(19) United States
(12) Patent Application Publication
(10) Pub. No.: US 2005/0162215 A1
(43) Pub. Date: Jul. 28, 2005

(54) Temperature sensing variable frequency generator

(75) Inventors: Kuen-Huei Chang, Hsinchu (TW); Yu-Chang Lin, Hsinchu (TW); Chieng-Chung Chen, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Winbond Electronics Corporation

(21) Appl. No.: 10/761,216

(22) Filed: Jan. 22, 2004

(51) Int. Cl. G05F 3/02

(52) U.S. Cl. 327/538

(57) ABSTRACT

A circuit for generating a current that comprises a first current generator providing a constant current in response to a constant voltage, a voltage generator providing a temperature dependent voltage, and a second current generator coupled to the voltage generator providing a variable current in response to the temperature dependent voltage.

### DESCRIPTION OF THE INVENTION

1. Field of the Invention

This invention pertains in general to a circuit for generating a current and more particularly, to a circuit for generating a temperature dependent current for a dynamic random access memory (“DRAM”) in refresh and restore operations.

2. Background of the Invention

A dynamic random access memory (“DRAM”) is a memory device including an array of memory cells. Each of the memory cells generally includes an access transistor and a storage capacitor. Typically, a logically high value, for example, logic “1”, is stored by charging the storage capacitor to a high voltage level, and a logically low value, for example, logic “0”, is stored by charging the storage capacitor to a low voltage level. A memory cell is a volatile element and may be subject to current leakage even if the access transistor of the memory cell is turned off. As a result, a memory cell must be periodically “refreshed” to maintain the state of a logic value stored therein. Furthermore, the logic value stored in a memory cell may inevitably be altered when it is read out. As a result, a restore operation, or write-back cycle, is needed to return the logic value to its original state for subsequent accesses.

Conventional techniques provide a constant current for a refresh or restore operation of a DRAM device. FIG. 1A shows an example of a conventional technique for a refresh operation. Referring to FIG. 1A, a circuit 10 includes a constant current source 12 and an oscillator 14. Constant current source 12 includes a current mirror (not numbered) formed by p-type metal-oxide-semiconductor (“PMOS”) transistors 12-2 and 12-4, and an n-type metal-oxide-semiconductor (“NMOS”) transistor 12-6 including a gate (not numbered) biased at a constant voltage V. Each of PMOS transistors 12-2 and 12-4 includes an electrode (not numbered) coupled to a power supply, for example, V_{DD}. Oscillator 14 includes a comparator 14-2, a capacitor 14-4 and a delay element 14-6. A constant current I provided by constant current source 12 charges capacitor 14-4, raising the voltage level at a non-inverting terminal X of comparator 14-2. When the voltage level at terminal X (V_{X}) exceeds a reference voltage level V_{REF} at an inverting terminal (not numbered) of comparator 14-2, the voltage level of an output terminal Y (V_{Y}) of comparator 14-2 becomes logic “1”. The logic “1” value is delayed for a time t_{d} by delay element 14-6 before it is transmitted to a gate (not numbered) of an NMOS transistor 14-8. When NMOS transistor 14-8 is turned on by the logic “1” value, capacitor 14-4 is discharged to ground, lowering V_{X} to a ground level. At this time point, V_{Y} turns from a logic “1” to a logic “0”, thus providing a time period t_{d} for a refresh operation, which is shown in FIG. 1B. Oscillator 14 provides a constant frequency because of the constant current I.

It has been found in the art that the need for a refresh operation in frequency is temperature dependent. For example, a refresh is performed for memory cells every 100 milliseconds (ms) at 85 degrees Celsius, and every 300 ms at 25 degrees Celsius. The conventional technique providing a constant frequency may result in unnecessary current consumption. Furthermore, it also has been found in the art that the need for a restore operation is temperature dependent. Generally, the restore time of a memory cell increases as an operation temperature decreases. It is thus desirable to have a circuit that can minimize power consumption in a refresh operation and reduce a restore time in a restore operation as well.

### SUMMARY OF THE INVENTION

Accordingly, the present invention is directed to a device and a method that obviate one or more of the problems due to limitations and disadvantages of the related art.

To achieve these and other advantages, and in accordance with the purpose of the invention as embodied and broadly described, there is provided a circuit for generating a current that comprises a first current generator providing a constant current in response to a constant voltage, a voltage generator providing a temperature dependent voltage, and a second current generator coupled to the voltage generator providing a variable current in response to the temperature dependent voltage.

In one aspect, the voltage generator includes a resistor having a temperature dependent resistance.

In another aspect, the voltage generator includes a current source, a temperature dependent resistor coupled to the current source, and an output terminal disposed between the current source and the resistor.

Also in accordance with the present invention, there is provided a circuit for generating a temperature dependent current that comprises a voltage generator providing a temperature dependent voltage, a current source of the voltage generator providing a constant current, a resistor of the voltage generator having a temperature dependent resistance, an output terminal of the voltage generator disposed between the current source and the resistor, and a current generator including a transistor having a gate coupled to the output terminal, the current generator providing a current in response to the temperature dependent voltage.

Further in accordance with the present invention, there is provided a circuit for providing a refresh cycle for a memory device that comprises a first current generator providing a first current in response to a constant voltage, a voltage generator providing a temperature dependent voltage, a second current generator providing a second current in response to the temperature dependent voltage, and a frequency generator providing a frequency in response to the sum of the first and second currents.

Still in accordance with the present invention, there is provided a circuit for providing a restore cycle for a memory device that comprises an input signal having a first state and a second state, a first voltage generator providing a constant voltage, a first current generator providing a first current in response to the first state of the input signal and the constant voltage, a second voltage generator providing a temperature dependent voltage, and a second current generator providing a second current in response to the temperature dependent voltage and the first state of the input signal.

Yet still in accordance with the present invention, there is provided a method of providing a refresh cycle for a memory device that comprises providing a constant voltage, generating a first current in response to the constant voltage, providing a temperature dependent resistance, generating a temperature dependent voltage by flowing a constant current through the resistor, generating a second current in response to the temperature dependent voltage, and generating a frequency in response to the sum of the first and second currents.

Further still in accordance with the present invention, there is provided a method of providing a restore cycle for a memory device that comprises providing an input signal having a first state and a second state, providing a constant voltage, generating a first current in response to the first state of the input signal and the constant voltage, providing a temperature dependent resistance, generating a temperature dependent voltage by flowing a constant current through the resistor, and generating a second current in response to the temperature dependent voltage and the first state of the input signal.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1A shows an example of a conventional technique for providing a refresh cycle;

FIG. 1B shows a timing diagram of an output of the conventional technique shown in FIG. 1A;

FIG. 2 is a voltage generator for providing a temperature dependent voltage in accordance with one embodiment of the present invention;

FIG. 3A is a circuit for providing a refresh cycle in accordance with one embodiment of the present invention;

FIG. 3B shows a timing diagram of an output of the circuit shown in FIG. 3A;

FIG. 4A is a circuit for providing a restore cycle in accordance with one embodiment of the present invention; and

FIG. 4B shows a timing diagram of an output of the circuit shown in FIG. 3A.

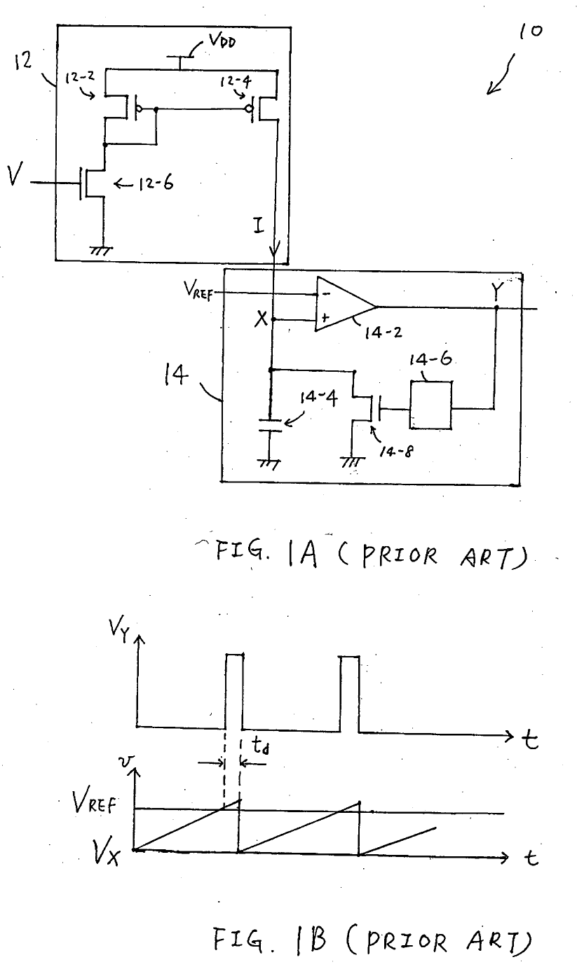

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

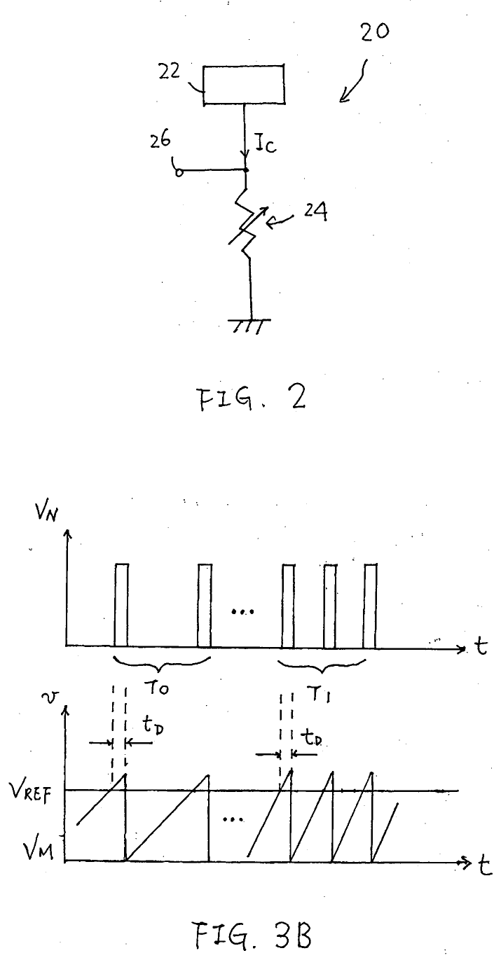

FIG. 2 is a voltage generator 20 for providing a temperature dependent voltage in accordance with one embodiment of the present invention. Referring to FIG. 2, voltage generator 20 includes a current source 22, a resistor 24, and an output terminal 26. Current source 22 provides a constant current I_{C}. Resistor 24 has a temperature dependent resistance, and is coupled between current source 22 and a reference voltage, for example, a ground level. In one embodiment, the resistance of resistor 24 increases as temperature increases, and decreases as temperature decreases. As a result, the voltage across resistor 24 is temperature dependent when constant current I_{C} flows through resistor 24. Output terminal 26 is disposed between current source 22 and resistor 24 to output the temperature dependent voltage.

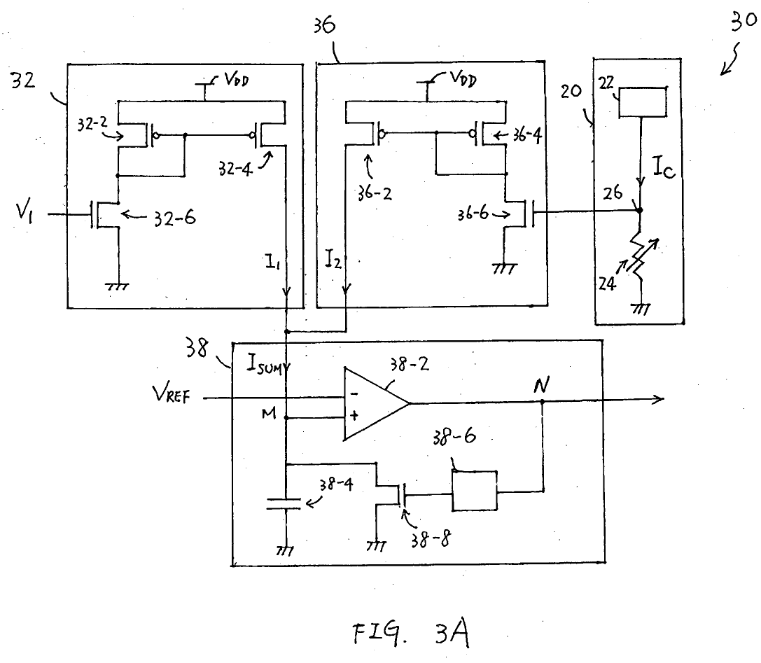

Voltage generator 20 is applicable to refresh and restore operations of memories, such as a dynamic random access memory (“DRAM”). FIG. 3A is a circuit 30 for providing a refresh cycle for a memory device (not shown) in accordance with one embodiment of the present invention. Referring to FIG. 3A, circuit 30 includes a first current generator 32, a voltage generator 20, and a second current generator 36. First current generator 32 includes a current mirror (not numbered) formed by p-type metal-oxide-semiconductor (“PMOS”) transistors 32-2 and 32-4, and an n-type metal-oxide-semiconductor (“NMOS”) transistor 32-6. Each of PMOS transistors 32-2 and 32-4 includes an electrode (not numbered) coupled to a power supply V_{DD}. transistor 32-6 includes a gate (not numbered) coupled to a voltage source (not shown) and biased at a constant voltage V₁ provided by the voltage source. First current generator 32 functions to provide a first current I₁. First current I₁ is a constant current whose magnitude is predetermined by constant voltage V₁.

Second current generator 36 includes a current mirror (not numbered) formed by PMOS transistors 36-2 and 36-4, and an NMOS transistor 36-6. NMOS transistor 36-6 includes a gate (not numbered) coupled to output terminal 26 and biased at a voltage V₂ provided by voltage generator 20. Second current generator 36 functions to provide a second current I₂ in response to voltage V₂. Second current I₂ is a variable current whose magnitude is determined by variable voltage V₂.

Circuit 30 further includes an oscillator 38, which receives first current I₁ and second current I₂. Oscillator 38 includes a comparator 38-2, a capacitor 38-4, and a delay element 38-6. First current I₁ provided by first current generator 32 and second current I₂ provided by second current generator 36 are added to become a sum current I_{SUM} before they are provided to oscillator 38.

In operation, when circuit 30 operates at a temperature T₀, current I_{SUM} charges capacitor 38-4, raising the voltage level at a non-inverting terminal M of comparator 38-2. When the voltage level at terminal M (V_{M}) exceeds a reference voltage level V_{REF} at an inverting terminal of comparator 38-2, the voltage level of an output terminal N (V_{N}) of comparator 38-2 becomes a logically high value, for example, logic “1”. The logic “1” value is delayed for a time t_{D} by delay element 38-6 before transmitted to a gate (not numbered) of an NMOS transistor 38-8. When NMOS transistor 38-8 is turned on by the logic “1” value, capacitor 38-4 is discharged to ground, lowering V_{M} to a ground level. At this time point, V_{N} turns from logic “1” to a logically low value, for example, logic “0”, thus providing a time period T_{D} for a refresh operation.

When circuit 30 operates at a temperature T₁, which is an increase from T₀, current I_{SUM} increases because I₁ remains unchanged and I₂ increases due to an increase in V₂. In accordance with the equation: Q=I×t, since the charging current I_{SUM} (I) increases, the time (t) required for charging capacitor 38-4 to a given capacity (0) decreases. As a result, oscillator 38 generates a first frequency at temperature T₁ greater than a second frequency at temperature T₀. In one embodiment, second current I₂ is cut off by turning off current source 22 of voltage generator 20 at temperature below a predetermined temperature, for example, 20 degrees Celsius.

FIG. 3B shows a timing diagram of an output of circuit 30 shown in FIG. 3A. Referring to FIG. 3B, when an operation temperature rises from T₀ to T₁, I₂ and in turn I_{SUM} increases. Capacitor 38-4 is charged and discharged more quickly at temperature T₁ than at temperature T₀. The frequency generated at temperature T₁ is greater than that at temperature T₀.

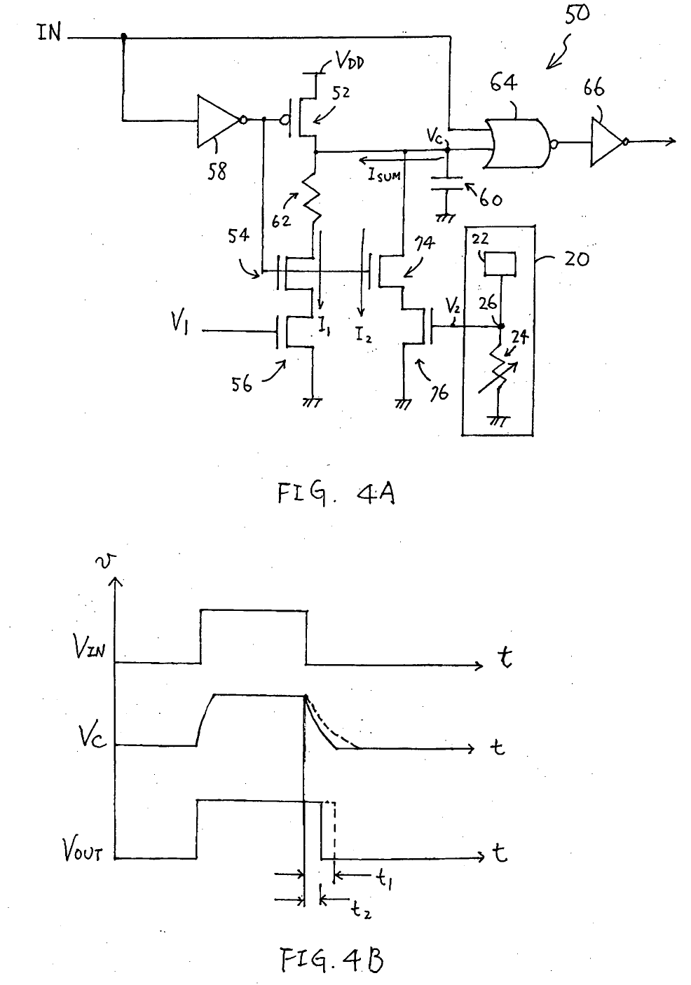

FIG. 4A is a circuit 50 for providing a restore cycle for a memory device in accordance with one embodiment of the present invention. Referring to FIG. 4A, circuit 50 includes an input signal IN, a first current generator (not numbered), a voltage generator 20, a second current generator (not numbered), and a capacitor 60. The first current generator includes a PMOS transistor 52, a first NMOS transistor 54, and a second NMOS transistor 56. The input signal IN is coupled to a gate (not numbered) of PMOS transistor 52 through an inverter 58. An output of inverter 58 is coupled to a gate (not numbered) of first NMOS transistor 54. Second NMOS transistor 56 includes a gate (not numbered) biased at a constant voltage V₁. Capacitor 60 includes one end coupled to a drain (not numbered) of PMOS transistor 52, and the other end coupled to a reference voltage, for example, ground.

The second current generator includes a first NMOS transistor 74, a second NMOS transistor 76, and capacitor 60. First NMOS transistor 74 includes a gate (not numbered) coupled to the output of inverter 58. Second NMOS transistor 76 includes a gate (not numbered) coupled to output terminal 26 of voltage generator 20 and biased at a temperature dependent voltage V₂ provided by voltage generator 20.

In operation, at the rising edge of input signal IN from a first state to a second state, for example, logic “0” and logic “1”, inverter 58 outputs a logically low value, which turns on PMOS transistor 52 and turns off first NMOS transistor 54 of the first current generator and first NMOS transistor 74 of the second current generator. Capacitor 60 is charged by a current from PMOS transistor 52 to a voltage level V_{C}. Circuit 50 outputs a logically high value through a NOR gate 64, which provides an output to an inverter 66.

At the falling edge of input signal IN from the second state to the first state, inverter 58 outputs a logically high value, which turns off PMOS transistor 52 and turns on first NMOS transistor 54 of the first current generator and first NMOS transistor 74 of the second current generator. Capacitor 60 is discharged to ground on one hand through a resistor 62, first NMOS transistor 54, and second NMOS transistor 56, and on the other hand through first NMOS transistor 74 and second NMOS transistor 76. During the discharge, a current I_{SUM} provided from capacitor 60 is divided into a first current I₁ flowing through the first current generator and a second current I₂ flowing through the second current generator. Second current I₂ is a temperature dependent current and increases as voltage V₂ increases. When the potential of capacitor 60, i.e. V_{C} falls within a logically low value, circuit 50 outputs a logically low value through NOR gate 64 and inverter 66.

FIG. 4B shows a timing diagram of an output of circuit 50 shown in FIG. 4A. Referring to FIG. 4B, in response to a logically high state of input signal IN, or V_{IN}, capacitor 60 is charged to V_{C} and an output of circuit 50, or V_{OUT}, is logically high. In response to a logically low state of input signal IN, capacitor 60 is discharged to ground to provide current I_{SUM} and V_{OUT} becomes logically low when V_{C} drops below a logically low state. A restore time refers to a time period measured from the falling edge of input signal IN to a point when V_{C} becomes logically low. Assuming that the restore time is t₁ at temperature T₁. When temperature increases from T₁ to T₂, I_{SUM} increases due to an increase in I₂. Capacitor 60 is discharged more quickly at temperature T₂ than at temperature T₁, resulting in a decrease of the restore time from t₁ to t₂.

The present invention also provides a method of providing a refresh cycle for a memory device. A constant voltage V₁ is provided. A first current I₁ is generated in response to the constant voltage V₁. A resistor 24 having a temperature dependent resistance is provided. A temperature dependent voltage V₂ is generated by flowing a constant current I_{C} through resistor 24. A second current I₂ is generated in response to the temperature dependent voltage V₂. A frequency in response to the sum of the first current I₁ and second current I₂ is generated.

In one embodiment, second current I₂ is cut off when an operation temperature falls below a predetermined point.

The present invention also provides a method of providing a restore cycle for a memory device. An input signal IN having a first state and a second state is provided. In one embodiment, the first state and the second state are respectively a logically low state and a logically high state. A constant voltage V₁ is provided. A first current I₁ is generated in response to the first state of input signal IN and constant voltage V₁. A resistor 24 is provided having a temperature dependent resistance. A temperature dependent voltage V₂ is generated by flowing a constant current I_{C} through resistor 24. A second current I₂ is generated in response to temperature dependent voltage V₂ and the first state of input signal IN.

In one embodiment, a capacitor 60 is discharged in response to the first state of input signal IN.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. (canceled)

2. The circuit of claim 8, wherein the voltage generator includes a resistor having a temperature dependent resistance.

3. (canceled)

4. The circuit of claim 9, wherein the temperature dependent resistance of the resistor increases as the temperature increases, and decreases as the temperature decreases.

5-7. (canceled)

8. A circuit for providing a refresh cycle for a memory device, comprising:
a first current generator providing a first current in response to a constant voltage;
a voltage generator providing a temperature dependent voltage;
a second current generator providing a second current in response to the temperature dependent voltage; and
a frequency generator providing a frequency in response to the sum of the first and second currents, the frequency generator comprising a comparator and a capacitor.

9. The circuit of claim 8, wherein the voltage generator includes a current source, a resistor having a temperature dependent resistance, and an output terminal coupled between the current source and the resistor.

10. The circuit of claim 9, wherein the second current generator includes a transistor having a gate coupled to the output terminal.

11. The circuit of claim 8, wherein the second current is turned off at a predetermined temperature.

12-24. (canceled)
